(19) United States
(12) Patent Application Publication
(10) Pub. No.: US 2018/0238505 A1
(43) Pub. Date: Aug. 23, 2018

(54) TOOL-LESS LIGHT ENGINE ASSEMBLY FOR LED STREET LIGHT FIXTURES

(71) Applicant: LED Roadway Lighting Ltd., Halifax, Nova Scotia (CA)

(72) Inventors: Ken Cartmill, Halifax, Nova Scotia (CA); Tristan Laan, Lewis Lake, Nova Scotia (CA)

(21) Appl. No.: 15/764,972

(22) PCT Filed: Oct. 3, 2016
(86) PCT No.: PCT/CA2016/051147

§ 371 Date: Mar. 30, 2018

Related U.S. Application Data
(60) Provisional application No. 62/236,603, filed on Oct. 2, 2015.

(51) Int. Cl. F21S 8/08; F21V 5/04; F21V 5/00; F21V 17/16; F21V 29/70; F21V 31/00

(52) U.S. Cl. CPC F21S 8/086; F21V 5/04; F21V 5/007; F21Y 2115/10; F21V 29/70; F21V 31/005; F21V 17/164

(57) ABSTRACT

A light emitting diode assembly is provided for using in street light fixtures. The light emitting diode assembly can be mounted in a street light fixture without the use of screws and is clipped into the body of the street light fixture. The assembly can be easily installed and is removable for maintenance.

### CROSS-REFERENCE TO RELATED APPLICATIONS

This application is a non-provisional application of U.S. Provisional Patent Application No. 62/236,603 filed Oct. 2, 2015, the entirety of which is hereby incorporated by reference for all purposes.

### TECHNICAL FIELD

The present disclosure relates to light emitting diode street lights and in particular to light engines for LED street light fixture.

### BACKGROUND

The installation and maintenance of light emitting diode (LED) engines in street light fixtures can be time consuming and difficult to perform particularly when performed in the field. Existing systems require screws to retain the engine and access components when a LED light engine needs to be replaced.

Accordingly, an improved LED light engine for street lights remains highly desirable.

### BRIEF DESCRIPTION OF THE DRAWINGS

Further features and advantages of the present disclosure will become apparent from the following detailed description, taken in combination with the appended drawings, in which:

FIG. 1 shows a perspective view of an LED light fixture with a tool-less LED light engine assembly;

FIG. 2 shows a top perspective view of the LED light fixture;

FIG. 3 shows a perspective view of an LED light fixture with the tool-less LED light engine assembly being removed;

FIG. 4 shows an LED light fixture with an open access compartment;

FIG. 5 shows a perspective view of the tool-less LED light engine assembly;

FIG. 6 shows the components of the tool-less LED light engine assembly;

FIGS. 7a and 7b shows a top and bottom view of the optics mounting bracket;

FIGS. 8a and 8b shows a top and bottom view an LED cover lens;

FIGS. 9a and 9b shows a top and bottom view of an optics gasket;

FIGS. 10a and 10b shows a top and bottom view of LED light engine; and

FIG. 11 shows a thermal pad.

It will be noted that throughout the appended drawings, like features are identified by like reference numerals.

### DETAILED DESCRIPTION

In accordance with an aspect of the present disclosure there is provided a tool-less light emitting diode (LED) engine assembly for a street light fixture comprising: an LED light engine having a plurality of LEDs positioned there on; a LED lens covers lens positions positioned on top of the LED light engine, the LED cover lens providing a plurality of lenses, each lens for covering an LEDs positioned on the LED engine for directing a light output of the respective LED in one or more a preferential directions; and an optics mounting bracket having a plurality of clips there on, a first set of the plurality of clips for engaging a receiving edge of an underside portion of the street light fixture to secure the light emitting diode assembly and a second set of clips for retaining the LED light engine and LED cover lens within the optics mounting bracket.

In accordance with another aspect of the present disclosure there is provided a light emitting diode (LED) street light fixture comprising: a light engine receiving portion on an underside of the LED street light fixture having a first receiving edge; and an LED light engine assembly comprising an optics mounting bracket having a plurality of clips there on, a first set of the plurality of clips for engaging the first receiving edge on the underside portion of the street light fixture and a second set of clips for retaining an LED light engine and a LED cover lens within the optics mounting bracket.

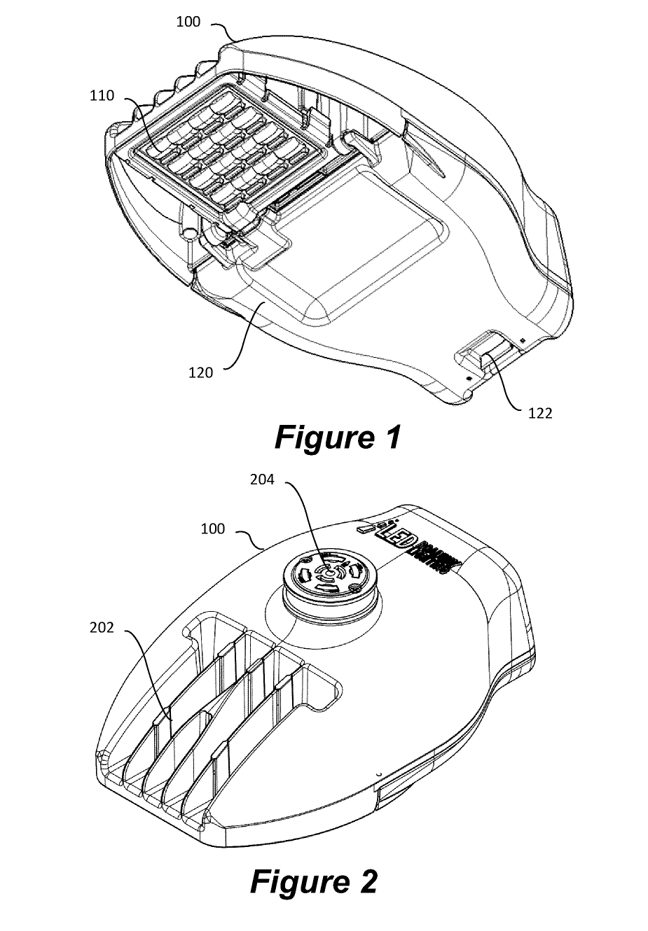

Embodiments are described below, by way of example only, with reference to FIGS. 1-11.

FIG. 1 shows a perspective view of an LED light fixture 100 having the tool-less LED light engine assembly 110. The LED light engine assembly 110 is positioned on the underside of the fixture which when mounted on a light pole projects light towards a surface to be illuminated such as a roadway. The LED light fixture 100 can also have an electronics compartment door 120 positioned behind the tool-less light engine assembly 110. The compartment door 120 has a latch 122 for containing electronics for powering the LED light engine assembly 110. The electronics of the light fixture can be accessed independently from the tool-less light engine assembly 110 and does not requirement removal of the tool-less light engine assembly 110.

FIG. 2 shows a top perspective view of the LED light fixture 100. The LED light fixture 100 may have fins 202 or vanes positioned above the LED light engine assembly to facilitate heat dissipation as required by the heat dissipation requirements of the LED light engine. A receptacle 204 is provided for mounting of a sensor, communications or location interfaces which can be used to control the LED light fixture engine 110.

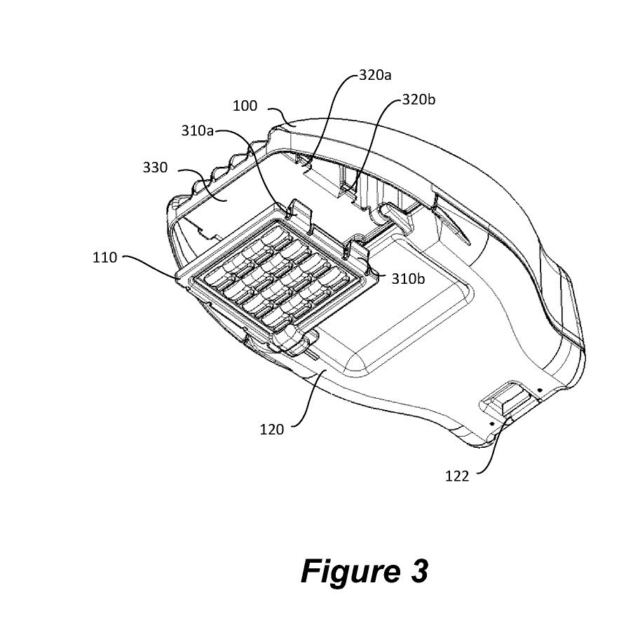

FIG. 3 shows a perspective view of an LED light fixture 100 with the LED light engine assembly 110 being removed. The LED light engine assembly 110 has retaining clips 310a 310b which engage with respective edges 320a 320b to hold the LED light engine assembly 110 in a light engine receiving portion 330 inside a recessed portion of the LED light fixture 100 body. Clips may be provided on both side of the assembly 110, alternatively a lip to provide a hinge or retaining groove may be provided on one side with the clips being provided on the opposite side of the assembly 110 which mates with a lip in the receive light engine receiving portion 330.

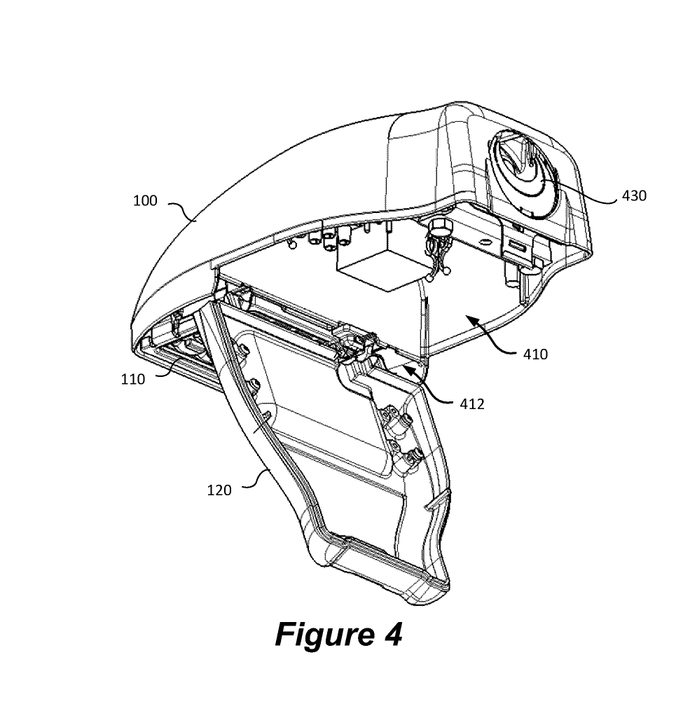

FIG. 4 shows an LED light fixture 100 with an open access compartment 410. The electronics compartment door 120 is hinged proximate to the LED light engine assembly 110 position which can be opened by disengaging latch 122 from the body of the LED light fixture 100. The compartment houses electronics such an power supply LED driver 410 and may also contain processors for controlling the light fixture. The power connector from the LED light engine assembly 110 is passed through an opening 412 for connection to the driver (not shown). The street light fixture 100 has an opening 430 for receiving a street light pole connection through which power connections can be provided.

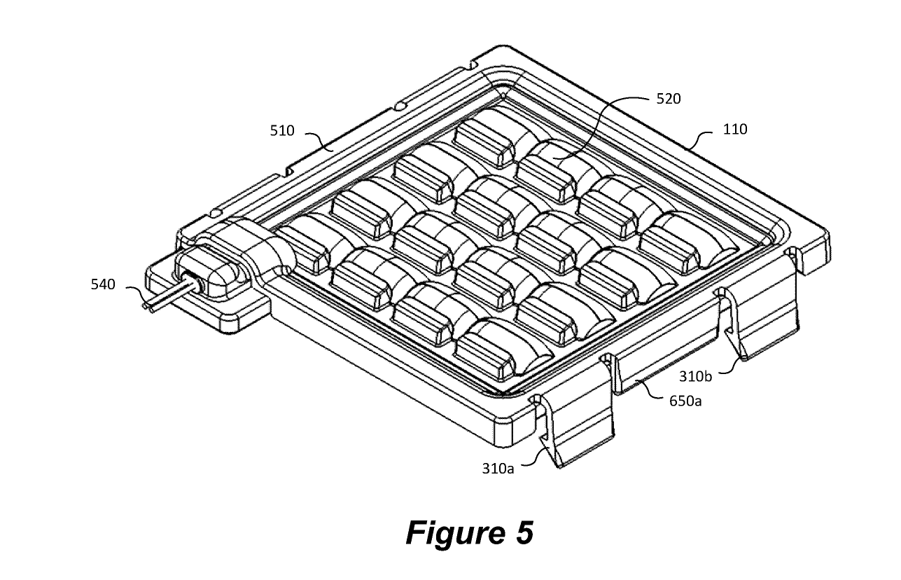

FIG. 5 shows a perspective view of the tool-less LED light engine assembly 110. The light engine assembly 110 has a mounting bracket 510 which provides a frame for retaining an LED cover lens 520 with the LED light engine in a single unit. The LED lens cover 520 may extend beyond the perimeter of the mounting bracket 510 to allow a power cable 540 to connect to the LED light engine assembly 110. The retaining clips 310a and 310b extend below an bottom edge defined by a perimeter of the mounting bracket 510 allowing the tool-less light engine assembly to be secured to the light fixture body. Additional retaining clips can be provided around the perimeter of the assembly 110 or cooperate with a matting edge or hook.

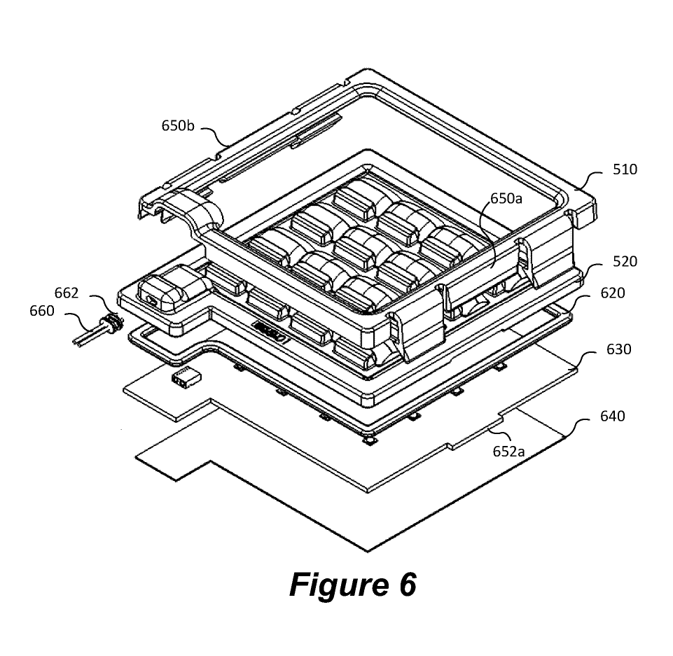

FIG. 6 shows the components of the LED light engine assembly 110. The LED light engine assembly 110 comprises component which can be layered on top of each other and held together by mounting bracket 510 using a retaining mechanism such as clips. The lens cover 520 covers a light engine 630 separated by an optics gasket 620. A thermal pad 640 may optionally be placed behind the light engine 630. The layers of the light engine assembly 110 are snapped together in the optics mounting bracket 510 by clips 650a and 650b which engage with protrusions such as 652a and 652b on the light engine 630. A power cable 660 can protrude from the lens cover through an opening sealed with a grommet 662.

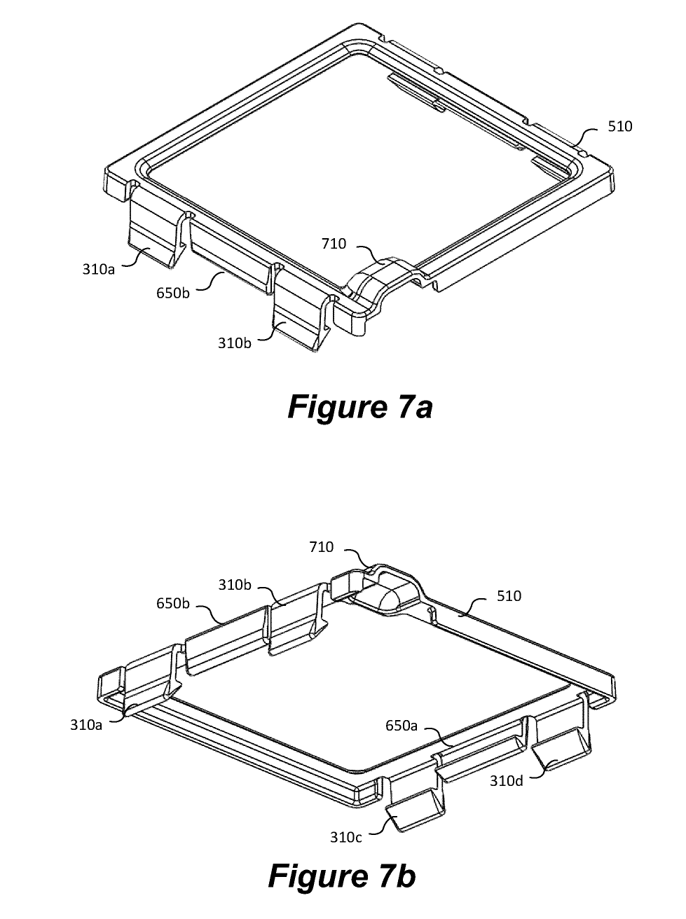

FIGS. 7a and 7b shows a top and bottom view of the optics mounting bracket 510. A port, bump or notch 710 is provided to allow power connections to be provided to the LED light engine via an extension of the LED cover lens 520. The optics mounting bracket 510 provides a frame for securing the lighting engine components together by retaining them in a single assembly.

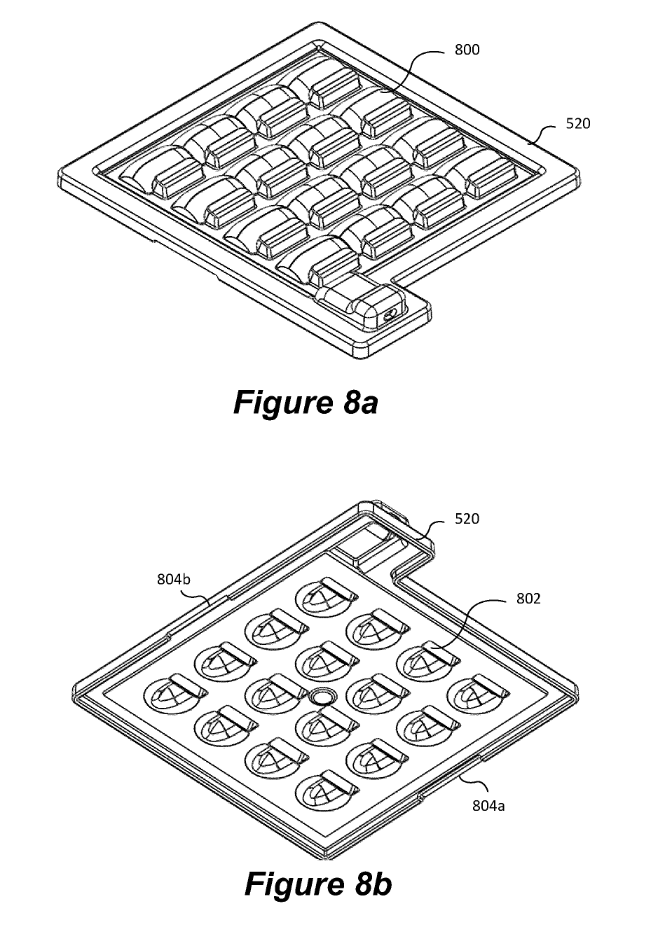

FIGS. 8a and 8b shows a top and bottom view an LED cover lens 520. The LED cover lens 520 has lens elements 800 for each LED on the light engine board 630 (shown in FIG. 6). The lens elements 800 are integrally formed in the lens cover. The lens elements 800 have a recess 802 on the underside of the LED cover lens 520 for receiving the LED on the light engine 630. The lens elements 800 enable projection of the light output of the LED in a desired direction or pattern. In the configuration shown, each of the lens elements 800 cover one of the LED on the light engine 630. The cover lens 520 can be made of an optically transparent material such as for example a polycarbonate. The LED cover lens 520 has notches 804a and 804b for receiving the protrusions 652a and 652b. The lens elements 800 are designed to accommodate the LED element of the LED light engine and therefore the configuration and pattern can be adapted to the number of LED elements provided.

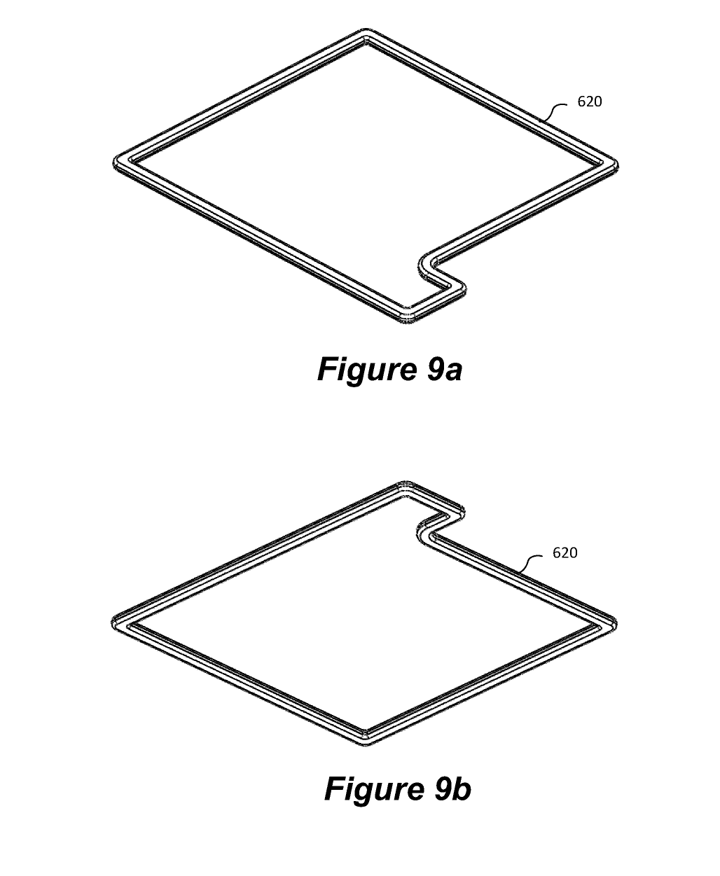

FIGS. 9a and 9b shows a top and bottom view of the optics gasket 620 which may be made of a material such as but not limited to rubber, plastic, or foam, to provide a water proof seal between the cover lens 520 and light engine 630 when compressed.

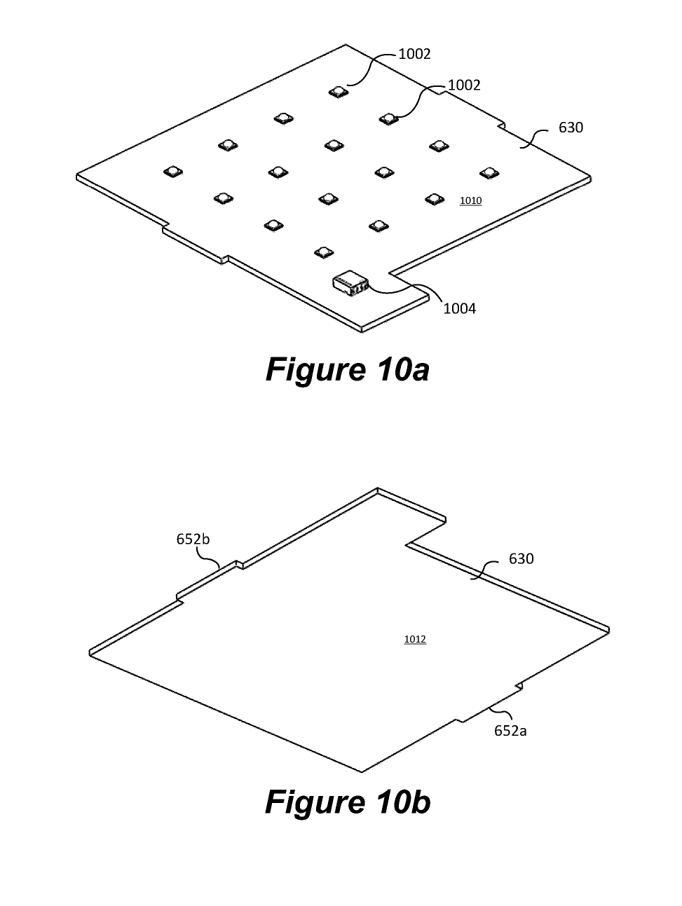

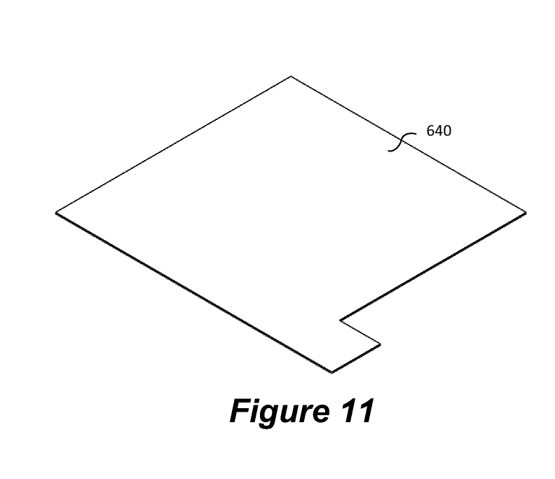

FIGS. 10a and 10b shows a top and bottom view of LED light engine 630. Referring to FIG. 10a multiple LEDs 1002 are mounted on the surface of the engine board made of a metal core printed circuit board, such as for example aluminum. In the configuration shown and array of 16 LEDs are mounted on a top surface 1010, although other numbers or arrangements of LEDs may be used. A plug 1004 or modular connector for receiving the power from the power cable 660 is mounted to the surface of the engine 630. Referring to FIG. 10b the bottom surface 1012 can provide a solid or continuous surface to reduce the possibility of water penetration. FIG. 11 shows a thermal pad 640 which may be applied, if required, to the surface 1012 to improve thermal conductivity with the LED light fixture housing.

The tool-less LED light engine assembly enables for easy removal and replacement from a light fixture particularly in in field application. The assembly can be clipped into place without the need for tools. In addition layers of components may be replaced within the assembly as required.

It would be appreciated by one of ordinary skill in the art that the system and components shown in FIGS. 1-11 may include components not shown in the drawings. For simplicity and clarity of the illustration, elements in the figures are not necessarily to scale, are only schematic and are non-limiting of the elements structures. It will be apparent to persons skilled in the art that a number of variations and modifications can be made without departing from the scope of the invention as defined in the claims. The shape and dimensions of the described LED light engine assembly may vary without departing from the scope of the invention.

1. A tool-less light emitting diode (LED) engine assembly for a street light fixture comprising:
an LED light engine;
a LED lens cover positioned on top of the LED light engine, for directing a light output of the respective LED in one or more preferential directions; and
an optics mounting bracket having a plurality of clips there on, a first set of the plurality of clips for engaging a receiving edge of an underside portion of the street light fixture to secure the light emitting diode assembly and a second set of clips for retaining the LED light engine and LED cover lens within the optics mounting bracket.

2. The LED light engine assembly of claim 1 wherein the LED lens cover comprises a plurality of lenses, each of the plurality of lenses covering an LED of the LED light engine.

3. The LED light engine assembly of claim 1 or 2 wherein the LED light engine and the LED cover lens is separated by an optics gasket.

4. The LED light engine assembly of claim 3 wherein the optics gasket is made of rubber, plastic or foam.

5. The LED light engine assembly of any one of claims 1 to 4 wherein LED cover lens is made of a polycarbonate.

6. The LED light engine assembly of any one of claims 1 to 5 wherein the LED cover lens has at least one recess for receiving an LED on the LED light engine.

7. The LED light engine assembly of any one of claims 1 to 6 further comprising a thermal pad, the thermal pad positioned between the LED light engine assembly and a body of the LED light fixture.

8. The LED light engine assembly of any one of claims 1 to 7 wherein a portion of the lens cover extends beyond an edge of the optics mounting bracket, the portion providing a port for a power cable from the LED light engine.

9. The LED light engine assembly of any one of claims 1 to 8 wherein the LED light engine is made from a metal core printed circuit board.

10. The LED light engine assembly of claim 9 wherein the metal core printed circuit board is made of aluminium.

11. The LED light engine assembly of any one of claims 1 to 10 wherein the light fixture has an access door for enable connecting a power connector of the LED light engine to a power supply.

12. The LED light engine assembly of any one of claims 1 to 11 wherein a bottom surface of the LED light engine is substantially free of perforations.

13. The LED light engine assembly of any one of claims 1 to 12 wherein the first set of the plurality of clips extends beyond the second set of the plurality of clips.

14. The LED light engine assembly of any one of claims 1 to 13 wherein the clips are disengaged by applying pressure away from the optics mounting bracket.

15. The LED light engine assembly of any one of claims 1 to 14 where in the plurality of clips are directed opposite to the direction of illumination of the LED cover lens.

16. The LED light engine of any one of claims 1 to 15 wherein the optics mounting bracket is substantially square.

17. The LED light engine of any one of claims 1 to 16 wherein the optics mounting bracket is substantially rectangular.

18. The LED light engine of any one of claims 1 to 17 wherein a portion of the LED light engine extends beyond the perimeter of the optics mounting bracket.

19. The LED light engine of any one of claims 1 to 18 where in at least one side of the optics mounting bracket is secured to the receiving edge by interfacing with a lip provided on the street light fixture opposite to a side providing the first set of clips.

20. A light emitting diode (LED) street light fixture comprising:
a light engine receiving portion on an underside of the LED street light fixture having a first receiving edge; and
an LED light engine assembly comprising an optics mounting bracket having a plurality of clips there on, a first set of the plurality of clips for engaging the first receiving edge on the underside portion of the street light fixture and a second set of clips for retaining an LED light engine and a LED cover lens within the optics mounting bracket.

21. The LED street light fixture of claim 20 wherein the LED lens cover comprises a plurality of lenses, each of the plurality of lenses covering an LED of the LED light engine.

22. The LED street light fixture of claim 20 or 21 wherein the LED light engine and the LED cover lens is separated by an optics gasket.

23. The LED street light fixture of claim 22 wherein the optics gasket is made of rubber, plastic or foam.

24. The LED street light fixture of any one of claims 20 to 23 wherein LED cover lens is made of a polycarbonate.

25. The LED street light fixture of any one of claims 20 to 24 wherein the LED cover lens has at least one recess for receiving an LED on the LED light engine.

26. The LED street light fixture of any one of claims 20 to 26 further comprising a thermal pad, the thermal pad positioned between the LED light engine assembly and a body of the LED light fixture.

27. The LED street light fixture of any one of claims 20 to 26 wherein a portion of the lens cover extends beyond an edge of the optics mounting bracket, the portion providing a port for a power cable from the LED light engine.

28. The LED street light fixture of any one of claims 20 to 27 wherein the LED light engine is made from a metal core printed circuit board.

29. The LED street light fixture of claim 28 wherein the metal core printed circuit board is made of aluminium.

30. The LED street light fixture of any one of claims 20 to 29 wherein the light fixture has an access door for enable connecting a power connector of the LED light engine to a power supply.

31. The LED street light fixture of any one of claims 20 to 30 wherein a bottom surface of the LED light engine is substantially free of perforations.

32. The LED street light fixture of any one of claims 20 to 32 wherein the first set of the plurality of clips extends beyond the second set of the plurality of clips.

33. The LED street light fixture of any one of claims 20 to 32 wherein the clips are disengaged by applying pressure away from the optics mounting bracket.

34. The LED street light fixture of any one of claims 19 to 32 where in the plurality of clips are directed opposite to a direction of illumination of the LED cover lens.

35. The LED street light fixture of any one of claims 20 to 34 wherein the optics mounting bracket is substantially square.

36. The LED street light fixture of any one of claims 20 to 35 wherein the optics mounting bracket is substantially rectangular.

37. The LED street light fixture of any one of claims 20 to 36 wherein a portion of the LED light engine extends beyond a perimeter of the optics mounting bracket.

38. The LED street light fixture of any one of claims 20 to 37 wherein the street light fixture comprises a plurality of fins on an upper surface opposite of the LED light engine assembly.

39. The LED street light fixture of any one of claims 20 to 38 wherein the fixture further comprising an electronic section positioned adjacent to the LED light engine assembly.

40. The LED street light fixture of claim 39 wherein the electronic section comprises a cover secured by a latch to the LED street light fixture.

41. The LED street light fixture of any one of claims 20 to 40 where the light engine receiving portion provides a lip for receiving a curved portion of the optics mounting bracket opposite the first set of the plurality of clips.
